(19) United States
(12) Patent Application Publication
(10) Pub. No.: US 2016/0015060 A1
(43) Pub. Date: Jan. 21, 2016

(54) Method for the Production of Fried Hop-Infused Starches

(71) Applicant: Christopher Adam Don, Manville, NJ (US)

(72) Inventor: Christopher Adam Don, Manville, NJ (US)

(21) Appl. No.: 14/608,159

(22) Filed: Jan. 28, 2015

Related U.S. Application Data
(60) Provisional application No. 61/937,739, filed on Feb. 10, 2014.

(51) Int. Cl. A23L 1/217

(52) U.S. Cl. CPC A23L 1/217; A23V 2002/00

(57) ABSTRACT

A novel method for the preparation of hop-infused marinated fried starches that makes them taste better.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of food preparation. More particularly, the present invention is in the technical field of fried starches. More particularly, the present invention is in the technical field of seasoned fried starches.

### SUMMARY OF THE INVENTION

The present invention is a fried starch product that has been marinated in an aqueous beer solution that is further infused with hops and spices measured in specific quantities.

### BRIEF DESCRIPTION OF THE DRAWINGS

FIG. 1 A semi-schematic diagram that illustrates the methods of preparing, peeling and slicing the potatoes as well as the preparation of the marinade and the hop sock.

FIG. 2 is a semi-schematic diagram that illustrates the methods of adding the hop sock and sealing the marinade chamber to for the prescribed amount of time.

FIG. 3 is a semi-schematic diagram that illustrates the methods of frying the hop fries as well as demonstrating the optional step of freezing the hop fries for storage.

FIG. 4 is a semi-schematic diagram that shows the method of seasoning the fries with the unique hop salt, as well as an illustration of how it may look, though other packaging and presentation will certainly be readily apparent to one skilled in the art.

### DETAILED DESCRIPTION OF THE INVENTION

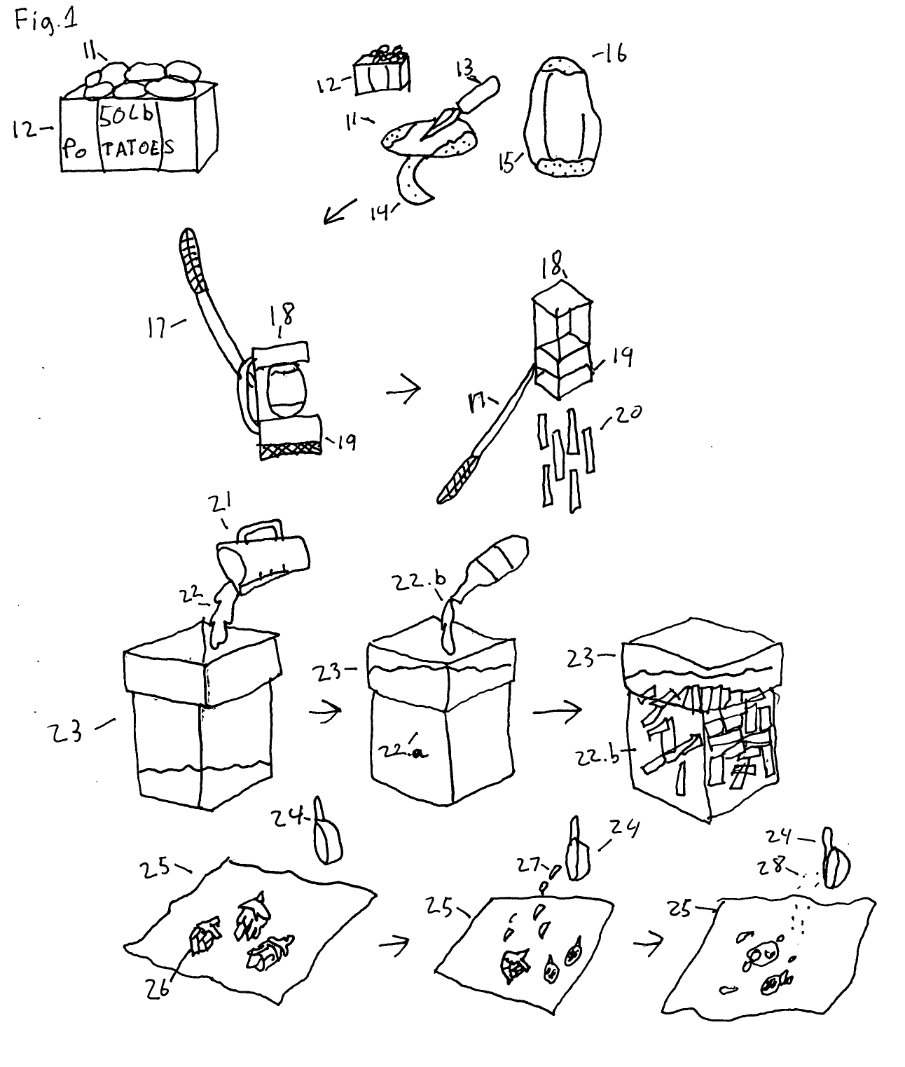

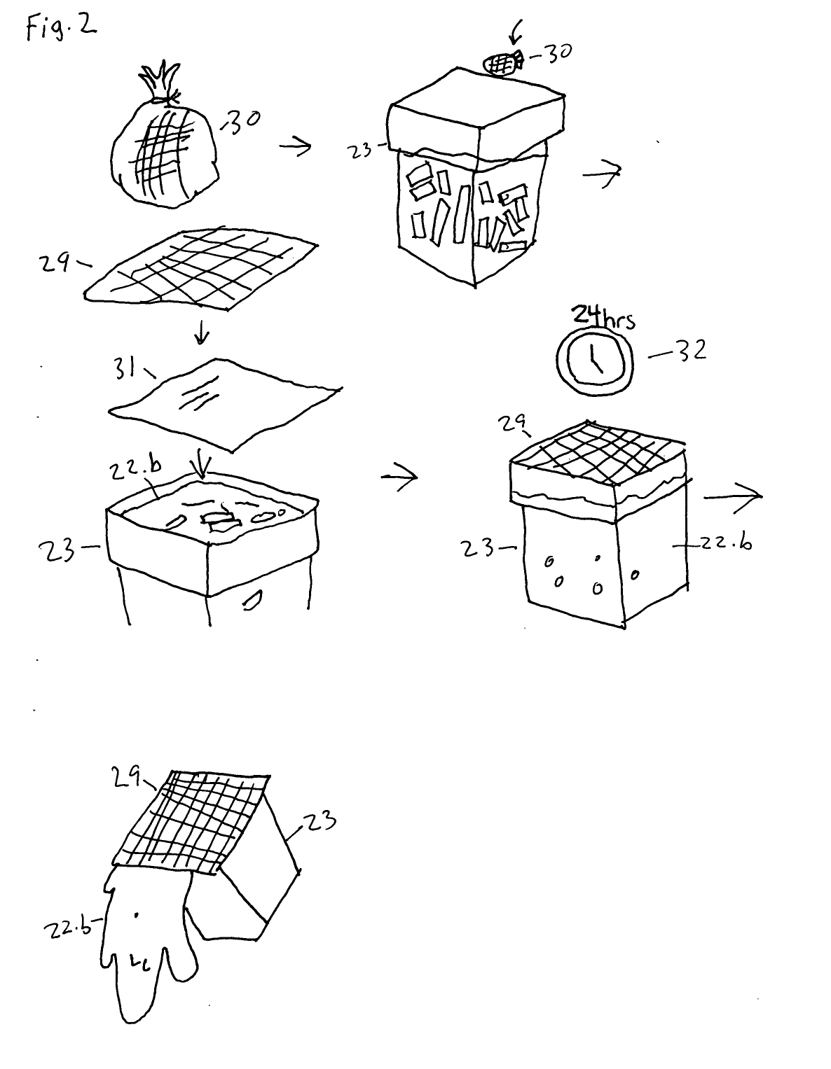

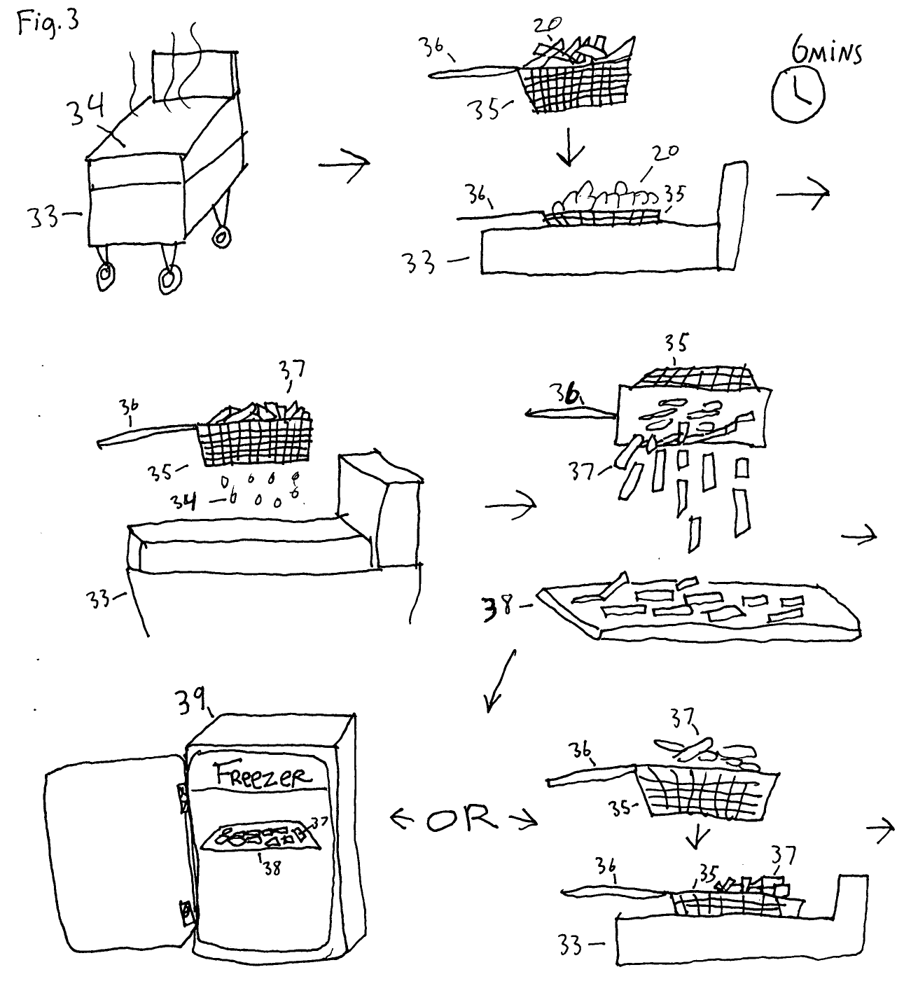

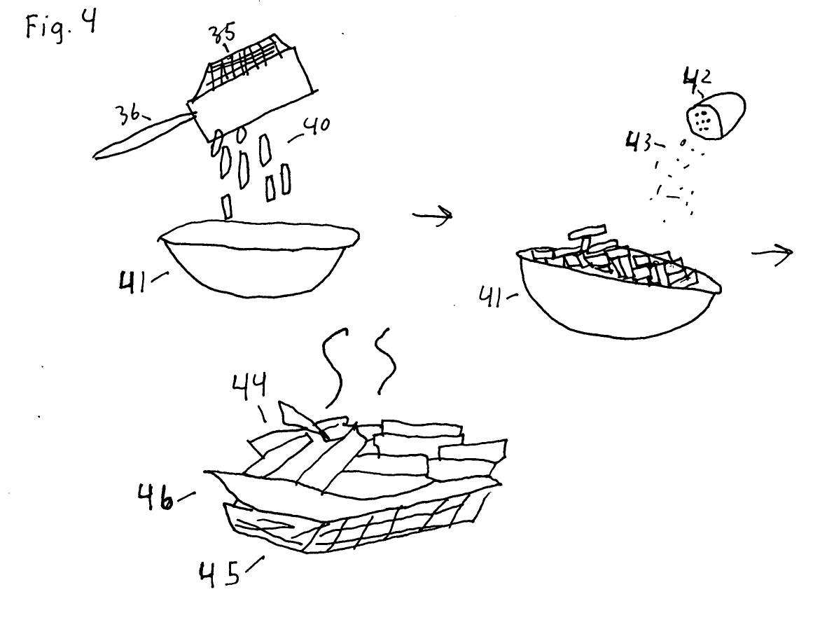

Referring now to the invention in more detail, in FIG. 1 to FIG. 4 there is shown potatoes 11 in case of potatoes 12, a vegetable peeler 13 is applied to potato 11 resulting in peel 14 being removed. Then it is shown a potato 11 with a sliced section 15 and unpeeled section 16. Now there is shown a french fry slicer 18 in which is placed the potato 11, a lever 17 is pulled down through slicer blades 19 leaving potato slices 20 in a food grade container 23 into which water 22 is poured from water pitcher 21, afterward a bottle of beer 22.b is shown suspended above food grade container 23 and into which the bottle of beer 22.b is poured into, which creates potato-marinade mixture 22.a. Next is shown measuring spoon 24 from which hops 26 have been measured out onto a cheesecloth 25, dried grapefruit peel 27 and coriander 28. Referring now to FIG. 2 there is shown the cheesecloth 25 converted into a pouch 30 tied with food grade twine which is then added into food grade bucket 23. Afterward cellophane sheet 31 is applied to potato-marinade mixture 22.a and food grade plastic lid 29 is placed on top. A clock 32 is then shown to indicate that a period of time must pass, before the potato-marinade mixture 22.a is dumped from food grade plastic bucket 23. Turning now to FIG. 3 a deep fryer 33 is shown in which flying substance 34 has been heated to sufficient temperature. Next is seen fry basket 35 and handle 36 which contains potato slices 20. This is shown being inserted into fryer 33. The fry basket 35 is then shown elevated out of flyer 33 allowing frying substance 24 to drip away from the once fried potato slices 37. Next is shown a side perspective of fry basket 35 from which once fried potato slices are dumped out on a sheet tray 38. At this point a choice of options is indicated, with either the sheet tray 38 being placed into a freezer 39, with the other option being to place the fried potato slices 40 back into fry basket 35 and fry them a second time in fryer 33. At this point referencing FIG. 4 in which a side perspective of fry basket 35, is shown suspended above a cooking bowl 41 in which fried potato slices 40 are emptied into. Afterward salt shaker 42 is applied over fried potato slices 40 covering them with hop-infused sea salt seasoning 43. Afterward is shown the finished invention fried hop-infused potato slices 44 sitting on a food grade paper liner 46 sitting in a paper fry boat 45.

In more detail, still referring to the actual preparation of the invention of FIG. 1 to FIG. 4 a potato 11 is selected from a case 12 of forty to sixty pounds of potato 11 and a peeler 13 is applied to the potato 11 leaving a potato 11 with a section that is unsliced 16 and a section that is sliced 15, and peel 14 is removed. The potato 11 with sliced 15 and unsliced 16 is placed with fry cutter 18 and lever 17 is operated push the potato 11 through the slicer blades 19 creating potato slices 20, which are added into a food grade container 23 that is capable of holding at least 90 cups of liquid without overflowing. Into this container place the potato slices 20 from potato 11, along with 220-300 ounces of water 22 then add 120-180 ounces of beer 22.b, creating a potato-marinade mixture 22.a. Now 1-4 ounces of hops 26 are placed onto a cheesecloth from a measuring spoon 24. Now 1-3 ounces of dried grapefruit peel 27 is added onto the bag, along with 1-3 ounces of coriander 28. Referring to FIG. 2 the cheesecloth 25 is now a pouch 30 that is tied with a food grade twine which is added into the potato-marinade mixture 22.a, At this point take a cellophane sheet 31 is added to the surface of the potato-marinade mixture and any and all air bubbles are removed to prevent oxidation and food grade lid 29 is added to the top of food grade container 23. Twenty-four hours should be allowed to pass, which is indicated by clock 32, afterward the potato-marinade mixture 22.a should be dumped out, leaving behind the potato slices 20. Referencing FIG. 3, there is a fryer 33 filled with frying substance 34 that is heated to a temperature of 290-310 degrees F. The potato slices 20 are placed with fry basket 35 and placed within the frying substance 34 for 4-8 minutes. The once fried potato-slices 37 are removed from the fryer 33 and the frying substance 34 is allowed to drip off. The once fried potato-slices 37 are then ready to cool and dry on a cooking sheet 38, after which time they can be placed in freezer 39 to freeze for storage, or placed back into a fry basket 35 and placed back into fryer 33 which has been heated to 340-360 degrees F. for 1-4 minutes. The fried potato slices 40 are visible if one references FIG. 4 and they dumped into a cooking bowl 41. The hop-infused sea-salt 43 is applied from salt shaker 42 onto the fried potato slices 40, creating the hop-infused fried potato slices 44.

The best method to make this invention is to use 50 pounds of potato 11, 240 ounces of water 22, 120 ounces of IPA beer 22.b, 24 ounces of double IPA beer 25, 2 ounces of hops 26, 1 ounce of dried grapefruit peel 27 and 1 ounce of coriander 28.

The advantages of the present invention include, without limitation, the marination process which is an innovation that has not been fully explored in the production of fried starches, providing a deep rooted taste in the final product. More over the hop-infusion provides a unique flavor that is further set off by hop-infused sea salt seasoning.

In broad embodiment, the present invention is a method by which fried starches can be produced in a way the makes them taste better.

All objects and ingredients shown in FIG. 1 to FIG. 4 and in this specification, including any accompanying claims, abstract, and drawings, may be replaced by alternate objects and ingredients which can served the same, equivalent or similar purpose, unless it is directly and explicitly stated otherwise. Thus, unless expressly stated otherwise, each object and ingredient described is only one example of a large series of generic, equivalent or similar objects and ingredients.

Moreover, any element in a claim that does not explicitly state “means for” performing a specified function, or “step for” in regards to performing a specific function, is not to be interpreted as a “means” or “step” clause as specified in 35 U.S.C. §112, paragraph 6. In particular, the use of “step of”, “added to” or “mixed with”, in the claims herein is not at all intended to invoke the provisions of 35 U.S.C. §112, paragraph 6.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method of producing fried hop-infused starches: a potato, water, beer, grapefruit zest, hops, frying substance and seasoning, wherein the potatoes are sliced and placed within the water and mixed with the beer, grapefruit zest, and hops and allowed to marinate for at least four hours before being fried in the frying substance and seasoned with seasoning.

2. The fried hop-infused starches of claim 1 further comprising: salt, coriander, garlic, paprika or smoked paprika, pepper, red pepper, chili peppers and allspice all of which are added with the hops into the beer-water mixture mentioned in claim 1.

3. The fried hop-infused starches of claim 1 can also be comprised of starches other than potatoes, including yams and sweet potatoes.
